(19) United States
(12) Patent Application Publication
(10) Pub. No.: US 2011/0200155 A1
(43) Pub. Date: Aug. 18, 2011

(54) Nuclear Reactor System and Nuclear Reactor Control Method

(76) Inventors: Atsushi Fushimi, Hitachi (JP); Setsuo Arita, Hitachiota (JP); Yoshihiko Ishii, Hitachinaka (JP); Tomohiko Ikegawa, Hitachi (JP); Shin Hasegawa, Mito (JP); Kazuhiko Ishii, Takahagi (JP)

(21) Appl. No.: 13/005,928

(22) Filed: Jan. 13, 2011

Related U.S. Application Data
(63) Continuation of application No. 11/657,456, filed on Jan. 25, 2007, now abandoned.

(30) Foreign Application Priority Data
Feb. 28, 2006 (JP) 2006-053067
Feb. 28, 2006 (JP) 2006-053068

(51) Int. Cl. G21C 7/08; G21C 7/36

(52) U.S. Cl. 376/217; 376/220

(57) ABSTRACT

In order to stably control a nuclear reactor in a short time, so as not to enter an unstable region that is determined by the relationship between the reactor pressure, the reactor power and the subcooling of the core inlet coolant at start-up time, the nuclear reactor system comprises: an power control apparatus for generating a control rod operation signal for operating a control rod, based on the reactor water temperature change rate; a feed water control apparatus for generating a feed water flow rate signal and a discharge water flow rate signals based on the reactor water level signal; and a process computer for performing overall control of the power control apparatus and the feed water control apparatus, wherein the feed water control apparatus has the reactor water temperature change rate setting section for adjusting the reactor water temperature change rate set value based on the variation of the reactor water level signal.

### CLAIM OF PRIORITY

This application is a continuing application of U.S. application Ser. No. 11/657,456, filed Jan. 25, 2007, the contents of which are incorporated herein by reference.

The present application claims priority from Japanese application serial no. 2006-053068, filed on Feb. 28, 2006 and Japanese application serial no. 2006-053067, filed on Feb. 28, 2006, the contents of which are hereby incorporated by reference into this application.

### BACKGROUND OF THE INVENTION

1) Field of the Invention

This invention relates to a nuclear reactor system and a nuclear reactor control method for a natural circulation boiling water reactor in which a coolant is circulated by natural circulation.

2) Related Art

Generally, boiling water reactors are largely divided into the forced circulation types and natural circulation types based on the circulation system for the coolant (cooling water). The forced circulation boiling water reactor (referred to as forced circulation reactor hereinafter) includes a jet pump or an internal pump or the like and this pump supplies cooling water into the core.

Meanwhile, the natural circulation boiling water reactor (called natural circulation reactor hereinafter) does not include a pump which circulates the cooling water by force as in the case of the forced circulation reactor. In the natural circulation reactor, the cooling water is circulated by the natural circulation force which is based on the difference in density (head difference) of the cooling water outside of the core shroud which surrounds the core and the two-phase flow including the steam and the cooling water inside the core shroud.

In this manner, in the natural circulation reactor, the cooling water is circulated by natural circulation force and thus it is difficult to obtain a cooling water flow amount in the core that is the same as the forced circulation type nuclear reactor in which the cooling water is circulated by force using a pump, and the ascending path at the upper portion of the core is elongated in order to promote recirculation. As a result, in order to shorten a nuclear reactor plant start-up time, the flow rate of the cooling water inside the core gets unstable in low pressure (about 1 MPa or lower) condition after start-up.

More specifically, when starting up the boiling water reactor (BWR), the core becomes a critical state by first withdrawing the control rod from the core. Neutron flux is increased, the cooling water temperature in the core is raised by nuclear heating to approximately 280° C. in the rated operation, and the reactor pressure is increased to 7 MPA. In this temperature and pressure increase step, the reactor power is adjusted by withdrawing the control rod such that the reactor water temperature is increased to be within 55° C./h of the limited value. In order to complete the temperature and pressure increase step within a short period of time, the temperature increase rate must be kept fixed at a value as close as possible to the limited value.

In particular, at the beginning of the temperature and pressure increase step, the main steam isolation valve is in a closed state and the reactor power and reactor water temperature increase rate are substantially proportional. Thus, the reactor power can be kept as high as possible within the range that does not exceed the limited value and this leads to reduced start-up time.

An advanced boiling water reactor (ABWR) is known in which the reactor power control apparatus is equipped with the function of operating the control rod so as to maintain a set temperature increase rate (see Japanese Patent No. 3357975, for example). It is also known that the economic simplified boiling water reactor (ESBWR) which is the natural circulation reactor requires similar control. However, in the low pressure state of ESBWR, because of specific flow rate instability in natural circulation reactors, there is the need to adjust reactor power to a stable level before operating (see Japanese Patent Laid-open No. Hei 5-256991, for example).

A natural circulation reactor is known in which, in order to stabilize the flow rate of the cooling water inside the core at start-up time, a heat exchanger is connected with the drain pipe connected to the lower plenum of the reactor vessel via a valve (Japanese Patent Laid-open No. Hei 6-265665). At the time of start-up of the natural circulation reactor at low pressure, the valve is opened and reactor water is sent to the heat exchanger. The reactor water that is heated by the heat exchanger is sent back to the inside of the lower plenum via the injection.

The reactor power control apparatus, as described in the abovementioned Patent No. 337975, is equipped with a change rate limiter in order to limit the increase rate of temperature change rate set values in the temperature and pressure increase step. This device is for preventing overshooting in the temperature change rate due to sudden increases in the set value at the time when control begins. Because the temperature change rate is changed with time, control cannot be performed such that the temperature change rate is reduced only when the reactor is in the unstable region. For this reason, in the case where the reactor power control apparatus is applied to the natural circulation reactor as it is, in order to avoid the instability of the natural circulation reactor at low pressures, when reducing the more reactor power than necessary in the temperature and pressure increase step, the start-up time is extended. In particular, the unstable region at low pressures transits to the high reactor power side with increase in reactor pressure. Thus, when the reactor power and the temperature increase rate is set based on the lowest pressure, the more increase rate than necessary is limited when the pressure is increased. Accordingly, operation burden is increased for the operator when the temperature increase rate setting is adjusted manually according to pressure and the advantage of automation of control rod operation is lost.

In addition, in the natural circulation reactor described in Japanese Patent Laid-open No. Hei 5-256991, the temperature of the reactor water increases due to nuclear heating from a state where the subcooling at the core inlet port is extremely large (approximately 50° C.) to a state where the subcooling is close to zero. Subsequently, in the state where the subcooling is close to zero is kept, a procedure for increasing pressure inside the nuclear reactor is indicated. However, in the nuclear heating step where a transition is made from a state where the subcooling is large to a state where the subcooling is close to zero, flow instability is actually generated.

In addition, in the natural circulation reactor of the prior art, the set value for the temperature change rate is constant. Thus, if the setting is done such that instability when pressure is lowest is avoided, there is inconvenience that when pressure increases, more reactor power than necessary is limited.

Furthermore, in the natural circulation reactor described in Japanese Patent Laid-open No. Hei 6-265665, the temperature of the reactor water is controlled only by the heat exchanger in accordance with the difference in the saturation temperature after the valve is opened. This temperature control is problematic in that how control is done is unclear. Thus, the unstable region determined by the relationship between the reactor pressure, the reactor power and the subcooling of the core inlet coolant is sometimes entered due to the reactor power and the reactor pressure.

Also, because the natural circulation reactor described in Japanese Patent Laid-open No. Hei 6-265665 uses a natural circulation system, no pump is provided but by simply opening the valve, the reactor water cannot be sent to the heat exchanger and the reactor water that has been heated by the heat exchanger cannot flow back from the injection tubes to the inside of the lower plenum. Thus the pump is needed even more in this case.

### SUMMARY OF THE INVENTION

The object of this invention is to control the nuclear reactor so as to become stable within a short time without increase the operational burden on the operator and without the reactor entering the unstable region which is determined by the relationship between the reactor pressure, the reactor power and the subcooling of the core inlet coolant at the time of start-up.

Another object of this invention is to give a simple structure and to control the nuclear reactor so as to become stable without entering the unstable region which is determined by the relationship between the reactor pressure, the reactor power and the subcooling of the core inlet coolant at the time of start-up.

In order to achieve the objects of this invention, the nuclear reactor system is formed a coolant ascending path and a coolant descending path in the reactor pressure vessel, and the nuclear reactor system has a natural circulation system in which the coolant is circulated due to the difference in density (buoyancy) of the coolant in the coolant ascending path and the coolant in the coolant descending path.

In addition, the nuclear reactor system of this invention comprises an reactor power control section for generating control rod operation signals for drawing out or inserting the control rod inside the reactor pressure vessel based on the reactor water temperature change rate; a feed water control section for generating the feed water flow rate signal for supplying the feed water into the reactor pressure vessel and the discharge water flow rate signal from discharging the discharge water from the nuclear reactor based on the reactor water level signal detected from the natural circulation system; and a process calculation section for overall control of the reactor power control section and the feed water control section, and the reactor water temperature change rate setting function which adjusts the set value for the reactor water temperature change rate based on the variation in the reactor water level signal is included in the reactor power control section, the feed water control section or the process calculation section.

In this manner, in the nuclear reactor system of this invention, the reactor water temperature change rate setting function monitors instability due to variation in the reactor water level, and in the case where the variation is large, the reactor water temperature change rate set value is reduced. In the case where the variation is small, the reactor water temperature change rate set value is increased.

Furthermore, in the case where the variation is large, the function for outputting control rod drive blocking signal blocks the control rod operation, or the function for outputting rod insertion signals performs insertion of the selected control rod into the core, so that the flow rate and water level can be kept stable.

More simply, any one of the reactor power and the temperature change rate that does not generate water level instability is stored in the start-up control apparatus as the function between at least the nuclear reactor pressure and the cooling water temperature at the reactor inlet port or as lookup table, and the temperature change rate set value can be adjusted based on the measured data from the reactor instrumentation system. It is to be noted that it is advantageous to include the function for the rod block and selected control rod insertion when the water level instability exceeds a fixed level.

In this manner, for example, by controlling the reactor water temperature change rate set value based on the variation of the reactor water level in order to be outside of the unstable region that is generated according to the reactor pressure, the reactor power and the subcooling of the core inlet coolant, the nuclear reactor is controlled to be stable within a short time such that the unstable region at start-up time is not entered.

The control method for the nuclear reactor of this invention is one which uses a natural circulation system in which the coolant is circulated due to the difference in density (buoyancy) of the coolant in the coolant ascending path and the coolant in the coolant descending path which are formed inside the reactor pressure vessel.

The control method for the nuclear reactor of this invention includes; a step of detecting the variation of the reactor water level based on the reactor water level signal detected from the natural circulation system; a step of determining whether or not the variation of the reactor water level is greater than a preset value; a step of reducing the set value for the reactor water temperature change rate which is set for the reactor pressure vessel when the variation in the reactor water level is greater than a preset value; a step of increasing the set value for the reactor water temperature change rate which is set for the reactor pressure vessel when the variation in the reactor water level is smaller than a preset value; and a step for determining whether the set value for the reactor water temperature change rate has been set to be outside the unstable region that is formed in accordance with the reactor pressure, the reactor power and the subcooling of the core inlet coolant at the time of start-up.

According to the control method of this invention, because the set value for the reactor water temperature change rate is controlled based on the variation of the reactor water level, the stability of the nuclear reactor can be controlled such that the unstable region at the time of start-up is never entered.

Furthermore, because the set value for the reactor water temperature change rate is controlled based on the variation of the reactor water level when the pressure became high too, the reactor can be controlled so as to be stable in a short period of time such that the unstable region-at the time pressure became high is never entered.

According to this invention, by controlling the set value for the reactor water temperature change rate based on the variation of the reactor water level, the reactor can be controlled so as to be stable in a short time such that the unstable region, which is determined by the relationship between the reactor pressure, the reactor power and the subcooling of the core inlet coolant at the time of start-up, is never entered to increase further start-up efficiency.

In this manner, in this invention, value setting for the temperature change rate is adjusted based on unstable state monitoring. Thus, it is possible for the temperature change rate to be always ideal and the start-up time can be shortened.

In addition, it is no longer necessary for the operator to frequently monitor instability state and adjust the temperature change rate, and the operational burden on the operator can be reduced.

In addition, this invention comprises a coolant clean-up section for pulling the coolant out of the reactor pressure vessel, cleaning up the coolant and returning it back to the natural circulation system; a heating section for heating the coolant that has been purified by the coolant clean-up section and a control section for controlling the subcooling which shows the temperature difference between the temperature in the reactor pressure vessel and the boiling point, by controlling the coolant temperature by the heating section at the time of start-up of the nuclear reactor system.

In this manner, the control section controls the coolant temperature by the heating section at the time of start-up of the nuclear reactor system, and thus controls the subcooling. For this reason, by controlling the subcooling so as to be outside the unstable region, which is produced according to the reactor pressure, the reactor power and the subcooling of the core inlet coolant, for example, the reactor is controlled so as to be stable and the unstable region at the time of start-up is never entered.

In addition, in the nuclear reactor system of this invention, the control section comprises a saturation temperature calculation apparatus for calculating the saturation temperature with respect to the pressure in the reactor pressure vessel; and a subcooling calculation apparatus for calculating the subcooling with respect to the internal pressure of the reactor pressure vessel. The control section controls the coolant temperature based on the saturation temperature calculated by the saturation temperature calculation apparatus and the subcooling calculated by the subcooling calculation apparatus.

The control section comprises a target temperature value calculation apparatus for calculating the target value of the temperature in the reactor pressure vessel based on the saturation temperature calculated by the saturation temperature calculation apparatus and the subcooling calculated by the subcooling calculation apparatus; a temperature calculation apparatus for calculating the temperature difference between the target temperature calculated by the target temperature value calculation apparatus and the temperature in the reactor pressure vessel; and a proportional-integral calculation apparatus for calculating the proportional-integral of the temperature difference obtained by the temperature calculation apparatus. The control section controls the coolant temperature in accordance with the calculation output from the proportional-integral calculation apparatus.

The control section comprises a pressure calculation apparatus for obtaining the pressure difference between the preset target pressure and the pressure in the reactor pressure vessel. The control section controls the coolant temperature based on the calculation output obtained by the proportional-integral calculation apparatus until no pressure difference is obtained by the pressure calculation apparatus.

In addition, in the nuclear reactor system of this invention, When the pressure in the reactor pressure vessel became low, the control section performs control such that the subcooling is reduced until outside the unstable region that is formed in accordance with the reactor pressure, the reactor power and the subcooling of the core inlet coolant at the time of start-up of the nuclear reactor system.

In addition, the control section determines whether control of the subcooling at the maximum temperature increase rate has started when the subcooling is decreased until outside the unstable region, which is formed in accordance with the reactor pressure, the reactor power and the subcooling of the core inlet coolant at the time of start-up of the nuclear reactor system, and when control of the subcooling at the maximum temperature increase rate has started, the subcooling is calculated and heating of the coolant that has been purified by the coolant clean-up section is controlled and a determination is made as to whether the subcooling has been increased until outside the unstable region.

In addition, the control section updates the subcooling when the subcooling is increased until outside the unstable region that is formed in accordance with the reactor pressure, the reactor power and the subcooling of the core inlet coolant, and controls the coolant temperature that has been purified by the coolant clean-up section, and determines whether the pressure in the reactor pressure vessel has attained the preset pressure target value.

In addition, the control section performs maximum temperature increase rate control until the pressure in the reactor pressure vessel attains the preset pressure target value.

In addition, the control method for the nuclear reactor of this invention is one which uses a natural circulation system in which the coolant is circulated due to the difference in density (buoyancy) of the coolant in the coolant ascending path and the coolant in the coolant descending path which are formed inside the reactor pressure vessel to control the reactor.

In addition, the control method for the nuclear reactor of this invention includes: a step of forming a coolant clean-up section which pulls the coolant out of the reactor pressure vessel and returns the coolant to the natural circulation system after purifying the coolant; a step of heating the coolant that has been purified by the coolant clean-up section; and a step of controlling the subcooling by controlling the coolant temperature by the heating process at the time of start-up of the nuclear reactor system.

According to the control method of this invention, by controlling the coolant temperature by the heating process at the time of start-up of the nuclear reactor system, because the subcooling is controlled, the reactor can be stably controlled such that it does not enter the unstable region that is determined by the relationship between the reactor pressure, the reactor power and the subcooling of the core inlet coolant at the time of start-up.

In addition, the control step includes the step of calculating the subcooling which shows the temperature difference between the internal temperature of the reactor pressure vessel and the boiling point; and the step for determining whether the subcooling has been lowered until outside the unstable region that is formed in accordance with the reactor pressure, the reactor power and the subcooling of the core inlet coolant at the time of start-up of the nuclear reactor system.

In addition, the control step heats the coolant that has been purified by the coolant clean-up section such that subcooling is reduced until outside the unstable region that is formed in accordance with the reactor pressure, the reactor power and the subcooling of the core inlet coolant at the time of start-up of the nuclear reactor system.

In addition, the control step comprises the steps of determining whether control of the subcooling has started at the maximum temperature increase rate when the subcooling is decreased until outside unstable region that is formed in accordance with the reactor pressure, the reactor power and the subcooling of the core inlet coolant at the time of start-up of the nuclear reactor system; a step of calculating the subcooling when control of the subcooling has started at the maximum temperature increase rate; and a step of controlling the coolant temperature that has been purified by the coolant clean-up section; and a step of determining whether the subcooling has been increased until the subcooling is outside the unstable region that is formed in accordance with the reactor pressure, the reactor power and the subcooling of the core inlet coolant.

In addition, the control step comprises a step of updating the subcooling when the subcooling is increased until outside the unstable region that is formed in accordance with the reactor pressure, the reactor power and the subcooling of the core inlet coolant, and controlling the coolant temperature that has been purified by the coolant clean-up section; and a step of determining whether the internal pressure of the reactor pressure vessel has attained the preset pressure target value.

Furthermore, the control step stops heating of the coolant that has been purified by the coolant clean-up section up until the point where the pressure in the reactor pressure vessel attains the preset pressure target value.

According to this invention, the flow rate of cooling water inside the core at the time of start-up can be made stable, and furthermore, because the existing coolant clean-up section can be used together with the natural circulation system at the time of start-up, the reactor can be stably controlled so as not to enter the unstable region that is determined by the relationship between the reactor pressure, the reactor power and the subcooling of the core inlet coolant at the time of start-up. Furthermore, by using the water clean-up system (CUW), the circulation efficiency of the natural circulation system can be increased.

### Frequency

### BRIEF DESCRIPTION OF THE DRAWINGS

FIG. 1 is a pattern diagram showing the overall structure of the natural circulation reactor according to an embodiment of a nuclear reactor system of present invention.

FIG. 2 is a block diagram showing the detailed structure of the temperature increase rate setting section.

FIG. 3 is a block diagram showing the detailed structure of another temperature increase rate setting section.

FIG. 4 is a block diagram showing the detailed structure of an interlock signal generation section.

FIG. 5 is a block diagram showing the detailed structure of yet another temperature increase rate setting section.

FIG. 6 is an explanatory drawing showing enthalpy of the saturated water.

FIG. 7 is an explanatory drawing showing enthalpy of the compressed water.

FIG. 8 is an explanatory drawing showing control of the set value for the reactor water temperature change rate.

FIG. 9 is a flowchart for showing the control operation for the set value for the reactor water temperature change rate.

FIG. 10 is a pattern diagram showing the overall structure of the natural circulation reactor according to another embodiment of a nuclear reactor system of present invention.

FIG. 11 is a block diagram showing the detailed structure of a water clean-up system (CUW) and a control apparatus.

FIG. 12 is a drawing for describing control of the subcooling.

FIG. 13 is a flowchart showing the operation for controlling the subcooling.

### DESCRIPTION OF THE PREFERRED EMBODIMENTS

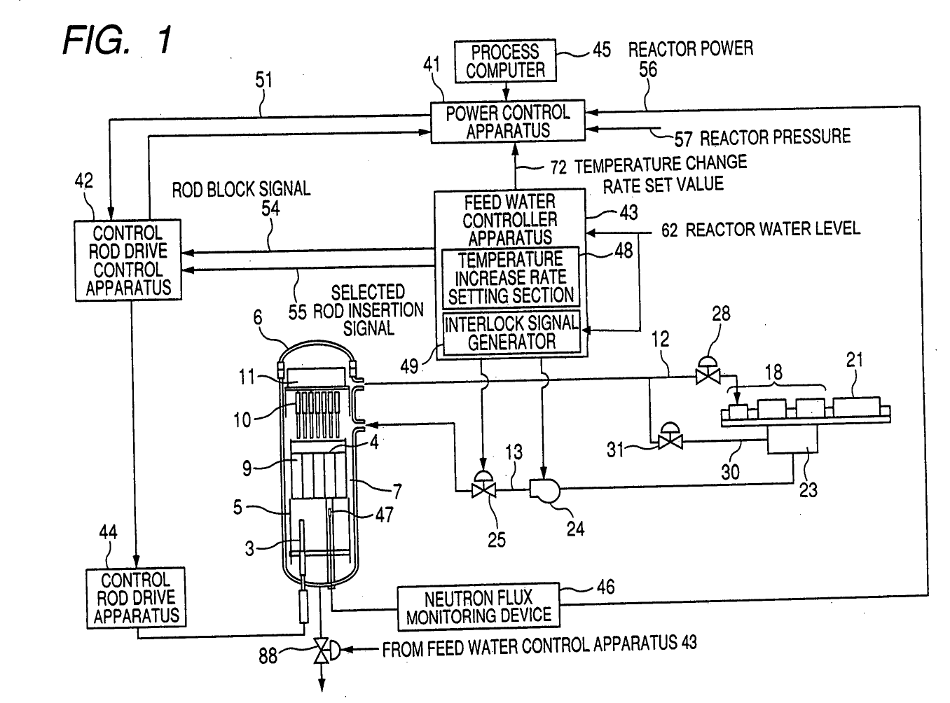

Embodiments of the nuclear reactor system and nuclear reactor control method of present invention will be described in the following with reference to the drawings. FIG. 1 shows the overall structure of a natural circulation boiling water reactor according to an embodiment of a nuclear reactor system of present invention.

As shown in FIG. 1, the natural circulation boiling water reactor (called natural circulation reactor hereinafter) comprises a core 4 in which control rods 3 is inserted into the space between a plurality of fuel assemblies including a plurality of fuel rods inside a reactor pressure vessel 6.

The lower portion of the reactor pressure vessel 6 has a control rod drive apparatus 44 which drives the control rod 3 in the vertical direction such that it can be inserted in and withdrawn from the core 4. A main steam pipe 12 and a feed water tube 13 are connected to the reactor pressure vessel 6. A cylindrical shroud 5 placed so as to surround the core 4 is inside the reactor pressure vessel 6.

A coolant ascending path for the coolant to ascend in the upper direction is formed inside the shroud 5. A downcomer 7 which is a coolant descending path for the coolant to descend are formed between the shroud 5 and the reactor pressure vessel 6. A circulation path of the coolant including the coolant ascending path and the coolant descending path is formed in the pressure vessel 6. A cylindrical chimney 9 is installed on the upper side of the shroud 5. A steam separator 10 and a steam drier 11 are provided at the upper side of the chimney 9.

The coolant of the two-phase flow including cooling water and steam passes through the inside of the chimney 9 which is inside the reactor pressure vessel 6. The steam is generated in the core 4 by the boil of the cooling water. The coolant descend through the downcomer 7, then is introduced into the core 4, passes through the core 4 and then ascends into the chimney 9 by the difference in density between the two phase coolant and the single phase coolant which passes inside the downcomer 7. When the two-phase flow including the cooling water and steam exhausted from the chimney 9 passes through the steam separator 10, the steam is separated by the steam separator 10. The single phase cooling water separated by the steam separator 10 descends down the downcomer 7 another time, passes the lower part of the reactor pressure vessel 6 and is supplied into the core 4 in the shroud 5.

At the steam drier 11, the tiny water droplets are removed from the steam separated by the steam separator 10. The steam including no tiny water droplets is supplied to a turbine 18 via a main steam pipe 12. The turbine 18 is rotated by the supply of the steam. Power is generated by the rotation of a generator 21 connected with the turbine 18.

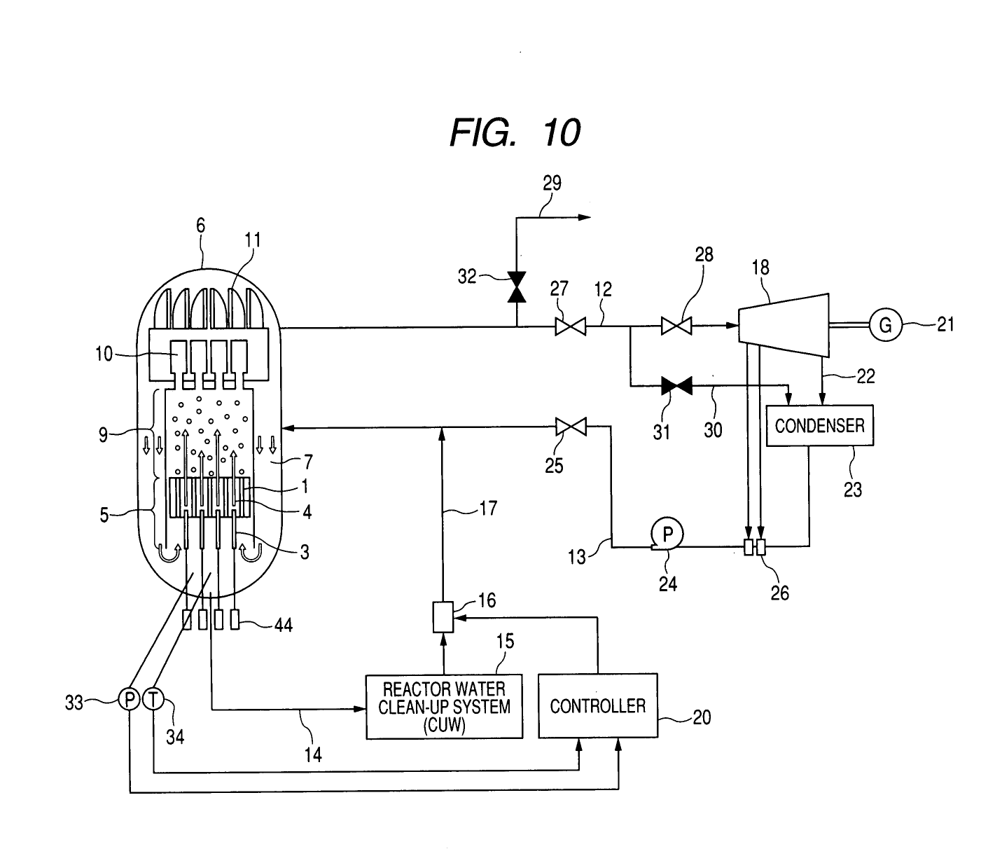

The steam exhausted from the turbine 18 is introduced into a condenser 23. The cooling water (condensed water) that has condensed in the condenser 23 is returned through a feed water tube 13 into the reactor pressure vessel 6 by a feed water pump 24. A flow rate adjusting valve 25 is provided in the feed water tube 13. Because the flow rate of the cooling water that is returned to the inside of the reactor pressure vessel 6 can be adjusted by the flow rate adjusting valve 25, the reactor water level in the reactor pressure vessel 6 can be controlled. As shown in FIG. 10, the feed water tube 13 has feed water heaters 26. In this feed water heaters 26, the steam extracted at a middle stage of the turbine 18 heats the cooling water supplied from the condenser 23 to a suitable temperature. The heated cooling water is introduced into the reactor pressure vessel 6.

As shown in FIG. 10 the main steam pipe 12 has a main steam isolation valve 27 and a turbine steam flow rate adjusting valve 28 which adjusts the amount of steam that is introduced into the turbine 18. As is also shown in FIG. 10, the relief pipe 29 and the bypass pipe 30 are connected to the main steam pipe 12. When the turbine steam flow rate adjusting valve 28 is closed, a turbine bypass valve 31 provided in the bypass tube 30 is opened and the steam is directly introduced into the condenser 23 via the bypass pipe 30 without any of the steam being introduced into the turbine 18. When the main steam isolation valve 27 is closed, the safety valve 32 provided in the relief pipe 29 is opened and the steam generated by the nuclear reactor is led into a suppression pool (not shown) in a containment vessel pool (not shown). The steam is condensed in the suppression pool.

In the present embodiment, a power control apparatus 41 generates a control rod operation signal 51 which is output to a control rod drive control apparatus 42 for moving the control rod 3 vertically inside the reactor pressure vessel 6, based on the reactor water temperature change rate that is set for the reactor pressure vessel 6. A feed water control apparatus 43 generates a feed water flow rate signal and a discharge water flow rate signals in order to adjust a feed water pump 24, a flow rate adjusting valve 25, and a discharge water flow rate adjusting valve 88 based on the reactor water level signal 62 which is detected by a water level detector 61 provided for the reactor pressure vessel 6. A process computer 45 outputs commands in accordance with preset process such that overall control of the power control apparatus 41 and the feed water control apparatus 43 is performed.

A feed water control apparatus 43 includes a temperature increase rate setting section 48 which has the reactor water temperature change rate setting function which adjusts the set value for the reactor water temperature change rate based on the variation of the reactor water level signal. It is to be noted that the temperature increase rate setting section 48 may also be included in the power control apparatus 41 or the process computer 45, and not the feed water control apparatus 43. The temperature increase rate setting section 48 which has the reactor water temperature change rate setting function controls a reactor water temperature increase rate set value 72 based on the variation of the reactor water level.

A interlock signal generator 49 in the feed water control apparatus 43 outputs a rod block signal 54 and a selected control rod insertion signal 55 to the control rod drive control apparatus 42 when the instability of the water level based on a reactor water level signal 62 is greater than a fixed level. When the drive control signal is output to a control rod drive apparatus 44 from the control rod drive control apparatus 42, the control rod drive apparatus 44 blocks the withdrawal of the control rod 3 from the core 4 and insertion of the selected control rod 3 into the core 4.

The temperature increase rate setting section 48 which has the reactor water temperature change rate setting function controls the reactor water temperature change rate set value 72 based on the variation of the reactor water level so as to be outside the unstable region that is formed in accordance with the reactor pressure, the reactor power and the subcooling of the core inlet coolant. As a result, the nuclear reactor can be stably controlled in a short time such that the unstable region at start-up time is never entered.

It is to be noted that a neutron flux detector 47 is provided in the reactor pressure vessel 6. The amount of neutron flux created by the nuclear reaction process can be obtained based on the detection signal from neutron flux detectors 47. Neutron flux monitoring device 46 which can obtain this neutron flux outputs the reactor power 56 to the power control apparatus 41 in accordance with the amount of neutron flux.

The reactor pressure vessel 6 provides a thermometer (not shown) for measuring the temperature of the cooling water in the reactor pressure vessel and a pressure gauge (not shown) for measuring the pressure in the reactor pressure vessel. A reactor pressure signal 57 and a temperature signal are input to the reactor power control apparatus 41. The pressure gauge may be an absolute value gauge or a differential pressure gauge.

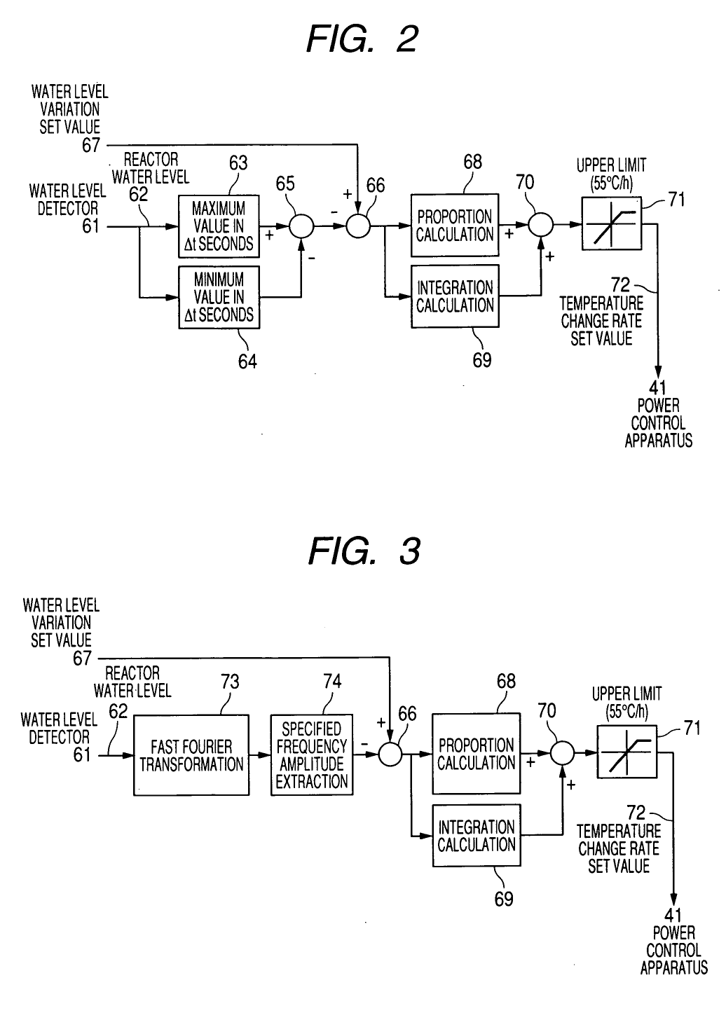

The detailed structure of the temperature increase rate setting section 48 and the interlock signal generator 49 in the feed water control apparatus 43 will be described in detail based on FIG. 2-FIG. 5. FIG. 2-FIG. 5 show the temperature increase rate setting section 48 and the interlock signal generator 49 shown in FIG. 1 in more detail. Parts that are the same as those in FIG. 1 have the same reference numbers. Description of functions of the device portions that have already been described in FIG. 1 is omitted.

In FIG. 2, the temperature increase rate setting section 48 which has the reactor water temperature change rate setting function calculates the maximum value in Δt seconds and the minimum value in Δt seconds at a maximum value calculation section 63 and a minimum value calculation section 64 based on the reactor water level signal 62 detected by the reactor water level detector 61. In addition, the calculated minimum value in Δt seconds is subtracted from the calculated maximum value in At seconds at a subtractor 65. The water level variation set value 67 is input to a subtractor 66. At the subtractor 66, the output from the subtractor 65 is subtracted from the water level variation set value 67.

The subtracted output value from the subtractor 66 is subjected to proportional calculation at the proportion calculation section 68 and integration calculation at the integration calculation section 69. The proportion value and the integration value are added at a adder 70. The upper limit value of the calculated output value from the adder 70 is limited by the limiter 71 and then input to the power control apparatus 41 as the reactor water temperature change rate set value 72.

As a result, a reactor water temperature change rate set value 72 is reduced in the case where the variation of the reactor water level based on the reactor water level signal 62 is large. The reactor water temperature change rate set value 72 is increased in the case where the variation of the reactor water level based on the reactor water level signal 62 is small.

In FIG. 3, another temperature increase rate setting section 48 which has the reactor water temperature change rate setting function inputs the reactor water level signal 62 detected by the reactor water level detector 61. A fast Fourier transformer 73 performs fast Fourier transformation for the water level signal 62. As a result, the reactor water level signal 62 for the time region is transformed in the frequency region. Next, the amplitude in the specified region is extracted from the reactor water level signal 62 transformed to the frequency region by a amplitude extractor 74 of the specified region. The amplitude extraction output value of the amplitude extractor 74 is subtracted from a water level variation set value 67 in a subtractor 66. The output from the subtractor 66 is input to the proportion calculation section 68 and the integration calculation section 69.

The proportion value from the proportion calculation section 68 and the integration value from the integration calculation section 69 are added at the adder 70. The upper limit value of the calculated output value from the adder 70 is limited by the limiter 71 and then output to the power control apparatus 41 as the reactor water temperature change rate set value 72.

As a result, the reactor water level signal 62 is subjected to fast Fourier transformation and the maximum amplitude in the prescribed frequency range is calculated, the reactor water temperature change rate set value 72 is reduced in the case where the maximum amplitude is large, and the reactor water temperature change rate set value 72 is increased in the case where the maximum amplitude is small.

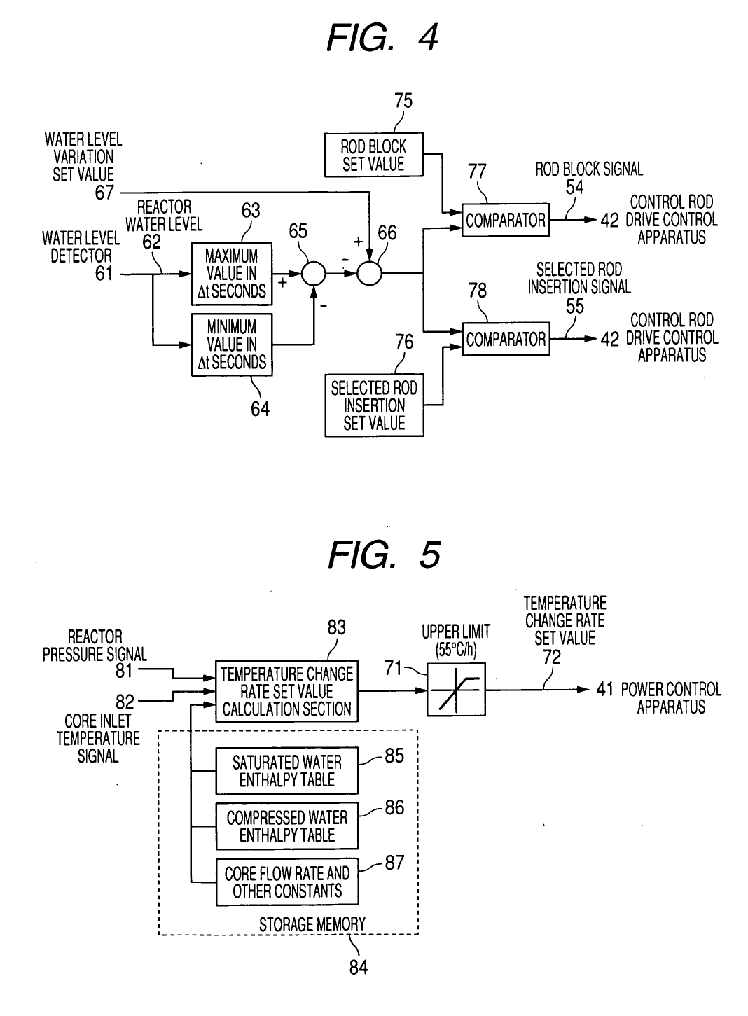

FIG. 4 is a block diagram showing the detailed structure of the interlock signal generator 49.

In FIG. 4, the water level signal 62 detected by the water level detector 61 is input to the interlock signal generator 49 of the feed water control apparatus 43. In addition, the maximum value in Δt seconds and the minimum value in Δt seconds are calculated at the maximum value calculation section 63 and the minimum value calculation section 64 based on the reactor water level signal 62. The minimum value in Δt seconds is subtracted from the maximum value in Δt seconds at the subtractor 65. The output from the subtractor 65 is input to the subtractor 66 and is subtracted from the water level variation set value 67.

The subtracted output value from the subtractor 66 is input to a comparator 77 and a comparator 78. At the comparator 77, the subtracted output value from the subtractor 66 is made proportional to the rod block value 75 and amplified rod block signal 54 is generated. At the comparator 78, the subtracted output value from the subtractor 66 is made proportional to a selected control rod insertion set value 76 and the amplified selected control rod insertion signal 55 is generated. The rod block signal 54 and the selected control rod insertion signal 55 are input to the control rod drive control apparatus 42.

When the variation of the reactor water level signal 62 is greater than the preset value 67, the interlock signal generator 49, which has the function of outputting the control rod insertion signal 55 that has been pre-selected, may be included in the reactor power control apparatus 41, the feed water control apparatus 43 or the process computer 45.

Also, when the variation of the reactor water level signal 62 is greater than the preset value 67, the interlock signal generator 49, which has the function of outputting the rod block signal 54, may be included in the power control apparatus 41 or the process computer 45.

In the case where the water level signal 62 is subjected to fast Fourier transformation and the maximum amplitude in the specified frequency region is calculated and when the maximum amplitude is greater than the preset value 67, the interlock signal generator 49 which has the function of outputting the selected control rod insertion signal 55 or the rod block signal 55 is included in the reactor power control apparatus 41 or the process computer 45.

FIG. 5 is a block diagram showing the detailed structure of another temperature increase rate setting section.

In FIG. 5, in the temperature increase rate setting section 48 which has another reactor water temperature change rate setting function, a reactor pressure signal 81 and a core inlet port temperature signal 82 are input to a temperature change rate set value calculation section 83. A saturated water enthalpy table 85, a compressed water enthalpy table 86 and the core flow rate and other constants 87 stored in a storage memory 84 are input to the temperature change rate set value calculation section 83.

The temperature change rate set value calculation section 83 calculates the temperature change rate set value calculation output based on a pre-stored function using the saturated water enthalpy table 85, the compressed water enthalpy table 86 and the core flow rate and other constants 87. In this function, the temperature change rate set value 72 is high to the extent that reactor pressure based on the reactor pressure signal 81 is high, and the temperature change rate set value 72 is high to the extent that the temperature at the reactor inlet port based on the core inlet port temperature signal 82 is low.

It is to be noted that the upper limit value of the temperature change rate set value calculation output is limited by the limiter 71 and then output to the power control apparatus 41 as the temperature change rate set value 72.

As described above, the function that is pre-stored in the temperature change rate set value calculation section 83 is such that the temperature change rate set value is high to the extent that the reactor pressure is high, and the temperature change rate set value is high to the extent that the core inlet port temperature is low. The following is a specific example of this function.

An example will be shown of a specific function for the flow instability phenomenon that is generated due to the start of boiling at the outlet port of the chimney 9. Given that the pressure of the upper plenum of the reactor pressure vessel 6 is P, the pressure at the outlet port of the chimney 9 is P−ΔP1, and the pressure at the core inlet port is P−ΔP2 (where ΔP1 and ΔP2 are constants), the reactor power Q for the limit where instability is not generated can be approximated as shown in the following Equation 1.

Q=W×[hsat(P−ΔP1)−hf(P−ΔP2, T)] [Equation 1]

wherein:

W is the core inlet port flow rate;

hsat is the enthalpy of the saturated water;

hf is the enthalpy of the compressed water;

P is the upper plenum pressure;

P−ΔP1 is the chimney outlet port pressure; and

P−ΔP2 is the core inlet port pressure.

Data for the enthalpy hsat of the saturated water and the enthalpy hf of the compressed water are stored in the storage memory 84 as the saturated water enthalpy table 85 and the compressed water enthalpy table 86. The values of the enthalpies hsat and hf can be obtained by interpolating and extrapolating those tables values into the temperature change rate set value calculation section 83.

At this time, given that the core inlet port flow rate is constant and the value is stored in advance, the reactor power Q for the limit where instability is not generated can be calculated from the upper plenum pressure P (P is normally used as the reactor pressure signal) and the core inlet port temperature T. Because steam is not extracted at the start of the temperature and pressure increase step, Q and the temperature change rate are proportional and can be approximated. Thus the temperature change rate set value can be obtained as shown in the following Equation 2.

Set temperature change rate=α×W×[hsat(P−ΔP1)−hf(P−ΔP2, T)] (α is a constant) [Equation 2]

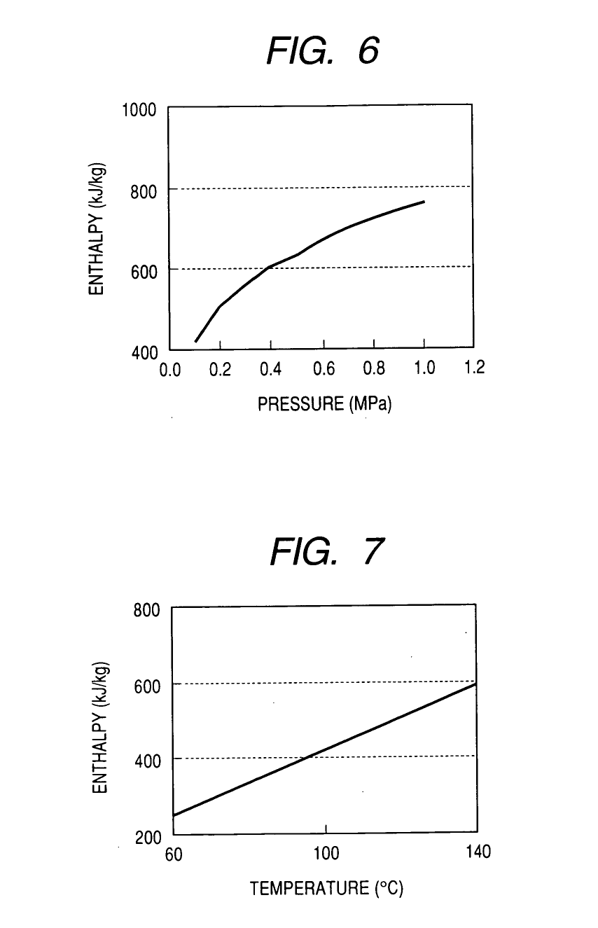

FIG. 6 shows enthalpy of the saturated water stored in the saturated water enthalpy table 85, and FIG. 7 shows enthalpy of the compressed water stored in the compressed water enthalpy table 86.

As seen from these drawings, the reactor water temperature change rate set value 72 can be determined by the pre-stored function using at least the reactor pressure signal 81 and the core inlet port temperature signal 82. It is to be noted that the reactor water temperature change setting function can be included in the power control apparatus 41 or the process computer 45.

The reactor power set value can be calculated by using at least the reactor pressure signal 81, the core inlet port temperature signal 82 and the pre-stored function. When the reactor power signal 56 that is based on neutron flux detection inside the reactor pressure vessel 6 exceeds the calculated reactor power set value, a selected control rod insertion signal 55 for the selected control rod 3 is output. The interlock signal generator 49 in the feed water control apparatus 43 which has this function may be included in the reactor power control apparatus 41, or the process computer 45, but not the feed water control apparatus 43.

The reactor power set value can be calculated based on at least the reactor pressure signal 81 and the core inlet port temperature signal 82 inside the reactor pressure vessel 6 using the pre-stored function. In the case where the reactor power signal 56 that is based on neutron flux detection in the reactor pressure vessel 6 exceeds the reactor power set value, the rod block signal 54 is output. The interlock signal generator 49 which has this function may be included in the power control apparatus 41, the feed water control apparatus 43, or the process computer 45, but not in the feed water control apparatus 43.

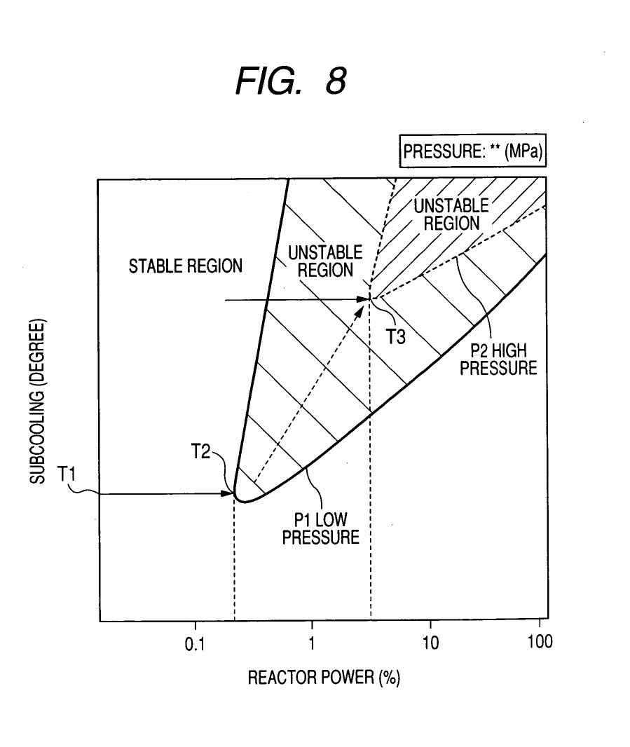

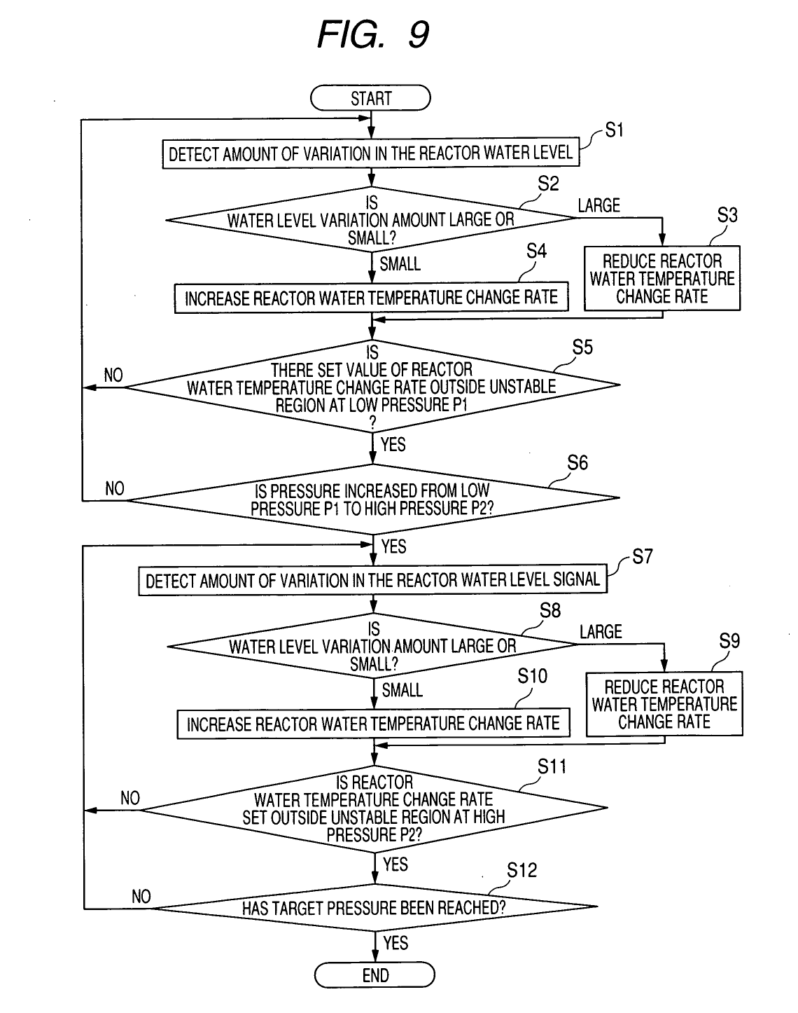

Next, control of the characteristic set value for the reactor water temperature change rate according to this embodiment will be described using FIG. 8 which describes control of the set value for the reactor water temperature change rate and FIG. 9 which is a flowchart showing the operation for controlling the set value for the reactor water temperature change rate.

The subject of the flowchart in FIG. 9 is the temperature increase rate setting section 48 of the feed water control apparatus 43.

First, the temperature increase rate setting section 48 detects the variation of the reactor water level based on the reactor water level signal 62 detected by the water level detector 61 (Step S1).

The temperature increase rate setting section 48 determines whether the variation of the reactor water level is greater than the preset value (Step S2).

The temperature increase rate setting section 48 reduces the reactor water temperature change rate set value set for the reactor pressure vessel 6 when the variation of the reactor water level is greater than a preset value (Step S3).

The temperature increase rate setting section 48 increases the reactor water temperature change rate set value set for the reactor pressure vessel 6 when the variation of the reactor water level is smaller than a preset value (Step S4).

The temperature increase rate setting section 48 then determines whether the reactor water temperature change rate set value at the time of the low pressure P1 is outside the unstable region, or in other words, it determines whether the reactor water temperature change rate set value has been set so as to be outside the unstable region that is formed in accordance with the pressure and temperature inside the reactor pressure vessel 6 at the time of start-up (at T1) (Step S5).

FIG. 8 is a drawing for describing control of the set value for the reactor water temperature change rate which corresponds to reactor power. As shown in FIG. 8, at the low pressure P1 at start-up time, the temperature increase rate setting section 48 raises the reactor power until immediately before the point where the unstable region is entered, so as to be outside the unstable region as shown from the point T1 to the point T2. Control is performed such that temperature is maintained in the stable region up the point immediately before the unstable region is entered.

In the flowchart of FIG. 9 also, in the case where it is determined that the reactor water temperature change rate set value has been set so as to be outside the unstable region that is formed in accordance with the reactor pressure, the reactor power and the subcooling of the core inlet coolant at the time of start-up (at T1) at the low pressure P1 in the Step S5, the temperature increase rate setting section 48 then determines whether the reactor pressure has been increased to the high pressure P2 from the low pressure P1 (Step S6). In other words, the temperature increase rate setting section 48 determines whether the pressure in the reactor pressure vessel 6 has attained the high rated pressure that is preset so as to correspond to the pressure from the low pressure P1 to the high pressure P2.

When it was determined in the determination steps S5 and S6 that the reactor water temperature change rate set value has not been set so as to be outside the unstable region that is formed in accordance with the pressure and the temperature in the reactor pressure vessel 6 at the time of start-up (at T1), and the pressure does not increase from the low pressure P1 to the high pressure, the procedure returns to step S1 and the determinations and process in step S1 to step S6 are repeated.

The temperature increase rate setting section 48 detects the variation of the reactor water level based on the reactor water level signal 62 detected by the water level detector 61 when it was determined in the determination step S6 that the reactor pressure increases from the low pressure P1 to the high pressure P2 (Step S7).

The temperature increase rate setting section 48 then determines whether the variation of the reactor water level is greater than a preset value (Step S8).

The temperature increase rate setting section 48 reduces the reactor water temperature change rate set value that is set for the reactor pressure vessel 6 when it was determined in the determination step S8 that the variation of the reactor water level is greater than a preset value (Step S9) and increases the reactor water temperature change rate set value when it was determined in the determination step S8 that the variation of the reactor water level is smaller than a preset value (Step S10).

The temperature increase rate setting section 48 determines whether the reactor water temperature change rate set value has been set so as to be outside the unstable region that is formed in accordance with the reactor pressure, the reactor power and the subcooling of the core inlet coolant at high pressure P2 (Step S11).

The temperature increase rate setting section 48 determines whether the pressure in the reactor pressure vessel 6 has attained a target pressure when it was determined in the determination step S11 that the reactor water temperature change rate set value has been set so as to be outside the unstable region that is formed in accordance with the reactor pressure, the reactor power and the subcooling of the core inlet coolant at high pressure (Step S12).

In the case where it was determined in the determination steps S11 and S12 that the reactor water temperature change rate set value has not been set so as to be outside the unstable region that is formed in accordance with the reactor pressure, the reactor power and the subcooling of the core inlet coolant at high pressure P2, and the pressure in the reactor pressure vessel 6 does not attain the preset target pressure, the procedure returns to step S7 and the determinations and process in step S7 to step S12 are repeated.

When the internal pressure of the reactor pressure vessel 6 attains the preset target pressure in the determinations step S12, the process ends.

It is to be noted that in FIG. 9, two different unstable regions (S1-S5 and S7-S11) are used due to the determination conditions for P1 and P2, but only P1 may be used or alternatively three or more determination conditions may be set and different processes for avoiding the respective unstable regions may be performed.

In this manner, as shown in the present embodiment, in the natural circulation reactor, because there is feedback on the reactor water level and the pressure and temperature increase step at the time of start-up is controlled and thus, the water level is prevented from exceeding the control value and thus the generation of scram is prevented. At the same time, the maximum temperature change rate is set in a range in which the stability of the reactor can be ensured and it becomes possible to reduce start-up time.

An embodiment of the present invention has been described above, but the present invention is not to be limited to the above embodiment, and needless to say, this invention includes various embodiments provided that they do not depart from the general spirit of the inventions described in the scope of the claims.

Another embodiment of the present invention will be described using FIG. 10 to FIG. 13. As shown in FIG. 10, the present embodiment has the same structure as that shown in FIG. 1.

In the present embodiment, a reactor water clean-up system (CUW) 15 pulls the coolant out of the reactor pressure vessel 6 and cleans it up. The purified coolant exhausted from the CUW apparatus 15 is heated by a heater 16 and supplied into the feed water pipe 13. The purified coolant is returned to the reactor pressure vessel 6 through the feed water pipe 13.

In this manner, the control apparatus 20 controls the subcooling which shows the temperature difference between the internal temperature of the reactor pressure vessel 6 and boiling point, by controlling heating of the coolant by the heater 16 at the time of start-up of the nuclear reactor system.

By controlling the subcooling so as to be outside the unstable region, which is formed based on the reactor pressure, the reactor power and the subcooling of the core inlet coolant, for example, the control apparatus 20 stably controls the reactor so not to enter the unstable region at the time of start-up.

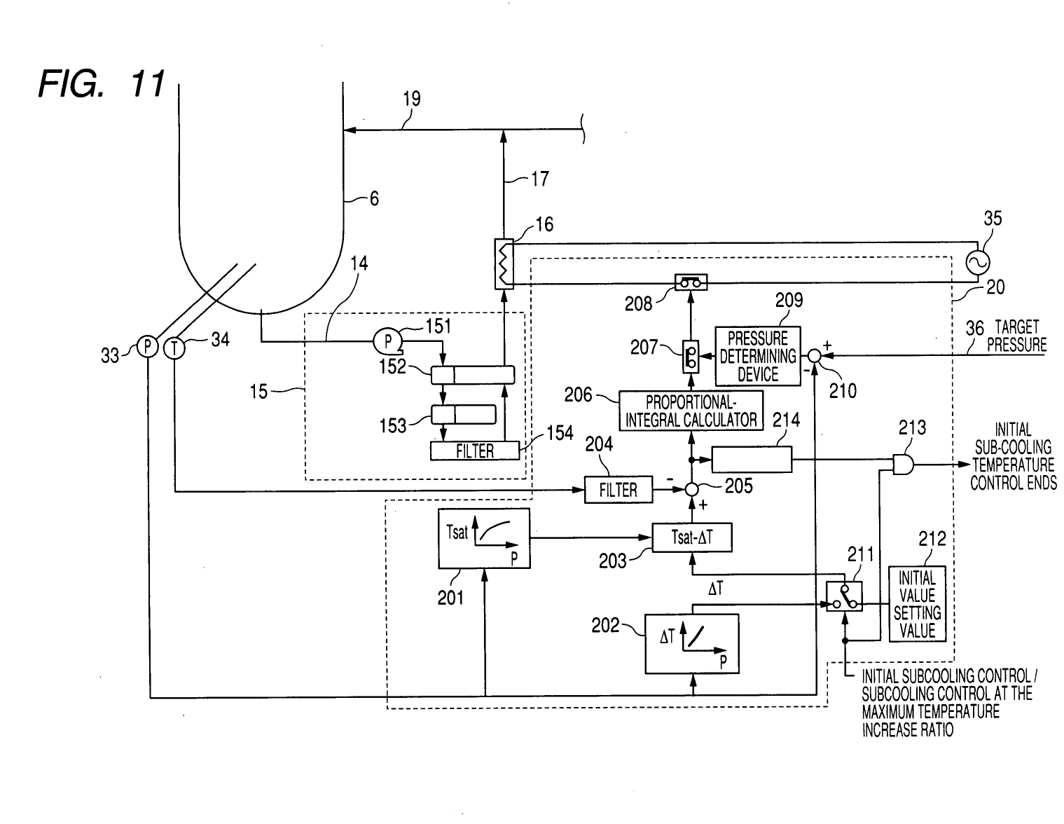

The CUW apparatus 15 and the control apparatus 20 will be described in detail in the following, based on FIG. 11. FIG. 11 is a diagram showing the detailed structure of the CUW apparatus 15 and the control apparatus 20. Parts that are the same as those in FIG. 1 have the same reference numbers. Description of functions of the device portions that have already been described in FIG. 1 is omitted.

According to the present embodiment, the reactor pressure vessel 6 provides at its lower portion, a thermometer 34 for measuring the temperature of the cooling water in the reactor pressure vessel 6 and a pressure gauge 33 for measuring the pressure in the reactor pressure vessel 6. The pressure gauge 33 may be an absolute value gauge or a differential pressure gauge.

The CUW apparatus 15 comprises: a pump 151 for sucking the cooling water (coolant) from the reactor pressure vessel 6 through a the coolant suction tube 14 provided at the lower portion of the reactor pressure vessel 6; a regenerative heat exchanger 152 and a non-regenerative heat exchanger 153 for cooling the cooling water exhausted from the pump 151; and a filter 154 for purifying the cooling water cooled by the regenerative heat exchanger 152 and a non-regenerative heat exchanger 153. A cooling water purified by the filter 154 is heated by regenerative heat exchange of the regenerative heat exchanger 152, it is supplied to the heater 16.

The control apparatus 20 herein comprises: a saturation temperature calculation apparatus 201 for calculating the saturation temperature with respect to the pressure of the reactor pressure vessel 6 measured by the pressure gage 33; and a subcooling calculation apparatus 202 for calculating the subcooling with respect to the measured pressure of the reactor pressure vessel 6. The control apparatus 20 controls the temperature of purified cooling water based on the saturation temperature calculated by the saturation temperature calculation apparatus 201 and the subcooling calculated by the subcooling calculation apparatus 202.

For this reason, the control apparatus 20 comprises a target temperature value calculation apparatus 203 for calculating the target value of the internal temperature of the reactor pressure vessel 6 based on the saturation temperature calculated by the saturation temperature calculation apparatus 201 and the subcooling calculated by the subcooling calculation apparatus 202; a subtractor 205 for obtaining the temperature difference between the target temperature calculated by the target temperature value calculation apparatus 203 and the temperature of the cooling water in the reactor pressure vessel 6 input via the filter 204 from the thermometer 34; and a proportional-integral calculator 206 for performing proportional-integral calculation for the temperature difference obtained by the subtractor 205. The control apparatus 20 controls the temperature of the purified cooling water in accordance with the calculated value output from the proportional-integral calculator 206.

Further, the control apparatus 20 comprises a subtractor 210 for obtaining the pressure difference between the preset target pressure 36 and the pressure in the reactor pressure vessel 6 measured by the pressure gauge 33. The control apparatus 20 controls the temperature of the purified cooling water based on the calculated value obtained by the proportional-integral calculator 206 until no pressure difference is obtained by the subtractor 210.

In the nuclear reactor system of the present embodiment, the control apparatus 20 performs the control at the time of low pressure such that subcooling reduced until it enters the region outside the unstable region that is formed in accordance with the reactor pressure, the reactor power and the subcooling of the core inlet coolant at the time of start-up of the nuclear reactor system.

For this reason, the control apparatus 20 controls the subcooling at the time of low reactor pressure such that the subcooling is constant until the increase rate of the temperature of the cooling water in the reactor pressure vessel 6 reaches the maximum temperature increase rate after start-up of the reactor system. Then the control apparatus 20 controls the subcooling so as to increase the subcooling until it is outside the unstable region formed in accordance with the reactor pressure, the reactor power and the subcooling of the core inlet coolant at the time when the increase rate of the temperature in the reactor pressure vessel 6 attains the maximum temperature increase rate.

The control apparatus 20 has a determining device 209 which determines whether the pressure in the reactor pressure vessel 6 has attained a pre-set target pressure 36. The control apparatus 20 controls the reactor power at the time of the high reactor pressure until it is determined by the pressure determining device 209 that the pressure in the reactor pressure vessel 6 reaches the preset target pressure 36.

For this reason, the control apparatus 20 comprises a switch 207 being controlled by the pressure determining device 209 such that first contact is in an ON state until the pressure in the reactor pressure vessel 6 has attains a pre-set target pressure 36 and outputting the calculated value from the proportional-integral calculator 206 in the ON state, and a switch 208 being controlled such that the second contact is in the ON state when the switch 207 is in the ON state, and supplying power voltage of the heater power source 35 to the heater 16 in the ON state of the second contact.

First the normal operation of the CUW apparatus 15 that has been configured in this manner will be described based on FIG. 11.

The cooling water in the reactor pressure vessel 6 is led to the pump 151 through the coolant suction pipe 14 provided at the lower part of the reactor pressure vessel 6. The pump 151 increases the pressure of the cooling water such that the purified cooling water which overcomes the pressure loss in the pipes and devices of the CUW apparatus 15 can be returned to the reactor pressure vessel 6 via the feed water pipe 13.

The cooling water being supplied to the filter 154 is sufficiently cooled by the regenerative heat exchanger 152 and the non-regenerative heat exchanger 153 so that the ion exchanged resin which is in the filter 154 not damaged by hot cooling water. The potential heat of the cooling water is recovered by the regenerative heat exchanger 152 and the heat loss in the reactor pressure vessel 6 is reduced. The non-regenerative heat exchanger 153 cools the cooling water to the operation temperature of the filter 154.

The filter 154 cleans the cooling water cooled by the regenerative heat exchanger 152 and the non-regenerative heat exchanger 153. A non-regenerative mixed ion-exchanged resin is in the filter 154.

After the cooling water purified by the filter 154 is heated by regenerative heat exchange of the regenerative heat exchanger 152, it is supplied to the heater 16.

As a result, the impurities being brought from the reactor pressure vessel 6 are removed and the cooling water can be maintained at a stipulated water quality. The impurities included in the cooling water are removed and induced radioactivity in the cooling water can be reduced.

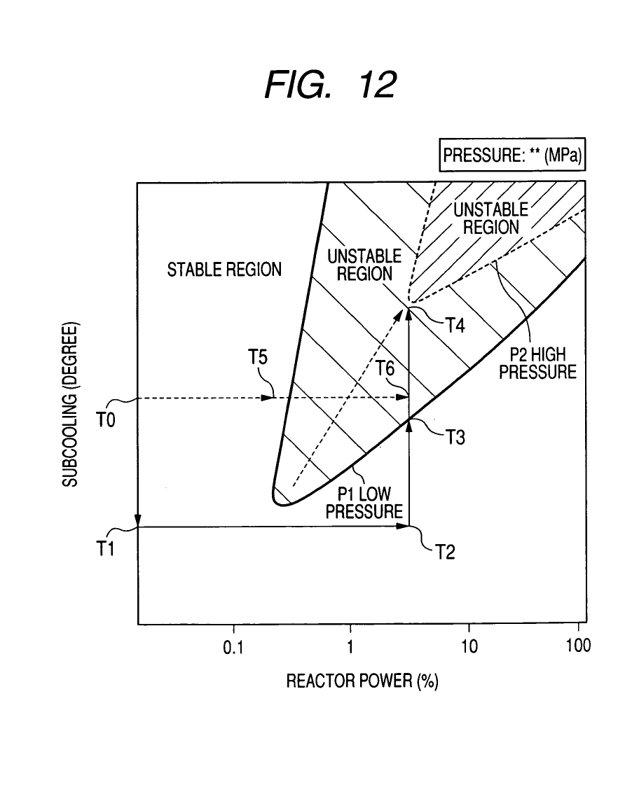

Next, control of the subcooling using the CUW apparatus 15 using the present embodiment will be described using FIG. 12 which is for describing control using the subcooling.

The CUW apparatus 15 forms a water clean-up system pulling the cooling water from the reactor pressure vessel 6 and then introducing the cooling water to the feed water pipe 13 after purifying the cooling water.

The heater 16 heats the cooling water purified by the CUW apparatus 15. At this time, the control apparatus 20 controls the subcooling which shows the temperature difference between the temperature of the cooling water in the reactor pressure vessel 6 and boiling point, by controlling the temperature of the cooling water by the heating process at the time of start-up of the nuclear reactor system.

The operation for control of the subcooling of the control apparatus 20 is described in detail in the following with reference to FIG. 11 and FIG. 12.

The target temperature value calculation apparatus 203 of the control apparatus 20 calculates the temperature target value of the cooling water in the reactor pressure vessel 6 based on the saturation temperature calculated by the saturation temperature calculation apparatus 201 and the subcooling ΔT being output by the control mode switch 211.

The subtractor 205 obtains the temperature difference between the target temperature calculated by the target temperature value calculation apparatus 203 and the temperature of the cooling water in the reactor pressure vessel 6 being output via the filter 204 from the thermometer 34. The proportional-integral calculator 206 performs proportional-integral calculation for the temperature difference obtained by the subtractor 205.

The pressure determining device 209 determines whether the pressure in the reactor pressure vessel 6 has attained a pre-set target pressure 36. A first contact of the switch 207 is controlled to be ON until it is determined by the pressure determining device 209 that the pressure in the reactor pressure vessel 6 is equal to a pre-set target pressure 36, and the calculated value from the proportional-integral calculator 206 is output from the switch 207.

The switch 208 is controlled such that a second contact is in an ON state using the output from the switch 207 and supplies power voltage from the heater power source 35 to the heater 16 in the ON state.

As a result, the temperature of the cooling water is controlled by the heater 16 in accordance with the calculated value from the proportional-integral calculator 206.

In the subtractor 210, the pressure difference between the preset target pressure 36 and the pressure in the reactor pressure vessel 6 from the pressure gauge 33 is obtained. Control of the temperature of the cooling water is performed in accordance with the calculated value from the proportional-integral calculator 206 until no pressure difference is obtained by the subtractor 210.

There are two types of control modes in subcooling control which are initial subcooling control, and subcooling control at the maximum temperature increase rate. These control modes are switched by the control mode switch 211. They are switched by external commands which are “initial subcooling control/subcooling control at the maximum temperature increase rate”. When “initial subcooling control” is input as a command, the control mode switch 211 switches to the initial value setting value 212. The initial value setting device 212 is set at the subcooling at T1 in FIG. 312 which is calculated in advance.

Thus, the heater 16 starts the control for heating the purified cooling water based on the power voltage such that the subcooling at T1 is reached. A determination can be made as to whether the subcooling has reached T1 by taking the logical product of the output from the equality determining device 214 inputting the output of the subtractor 205 and the external command “initial sub-cooling temperature control” by an AND circuit 213. That is to say, if the output from the subtractor 205 reaches zero when “initial subcooling control” is input to the AND circuit 213 as a command, a determination is made that the subcooling is reached at T1 which is the target value and the AND circuit 213 outputs “initial subcooling control end”.

When “initial subcooling control end” was output, a command signal is output to the control rod drive apparatus 44 shown in FIG. 10 using commands from the power control apparatus 41 (shown in FIG. 1), or by manual commands from the operator. The control rod 3 is withdrawn from the core 4 and the reactor power is increased until a preset reactor power value is reached. In this case, this corresponds to the output at T2 in FIG. 12. In point T2, the reactor power is constant and the reactor temperature and pressure are increased by the maximum temperature increase rate.

That is to say, in FIG. 12, by the subcooling being moved from the TO value to the T1 value at the time of start-up and then by moving the reactor power from the T1 value to the T2 value, the unstable region described above is avoided and thus it becomes possible to carry out temperature increase and pressure increase in the core in a short time. It is to be noted that because the reactor power is the amount of heat generation per unit of time, the reactor power is proportional to temperature increase rate.

When the reactor power reaches the T2 value, and the external command “initial subcooling control/subcooling control at the maximum temperature increase rate” becomes the command “subcooling control at the maximum temperature increase rate”, the control mode switch 211 is connected with the subcooling calculation apparatus 202. The subcooling calculation apparatus 202 calculates the subcooling ΔT in accordance with the input pressure. In the case of FIG. 12, a subcooling that is just outside the unstable range is obtained, by increasing the subcooling from the T2 value to the T3 value.

That is to say, this control is performed by controlling the amount of the heating of the heater 16, and heating from the heater 16 is controlled such that the target temperature value calculated by the target temperature value calculation apparatus 203 and the temperature of the cooling water in the reactor pressure vessel 6 being input from the thermometer 34 via the filter 204 are equal. The switch 208 is controlled so as to be ON and OFF by the calculated value by the proportional-integral calculator 206.

In the control step above, a control signal is output to the control rod drive apparatus 44 (shown in FIG. 10) based on the pre-set maximum temperature increase rate, using commands from the power control apparatus 41, or by manual commands from the operator. The control rod 3 is withdrawn from the core 4 by the control rod drive apparatus 44. Because the reactor temperature and the reactor pressure is increased by the withdrawal of the control rod 3, the unstable region shifts from the low pressure P1 to the high pressure P2. As a result, the subcooling for the value of point T3 is no longer a value that is almost in the unstable region and the subcooling can be increased to the value of point T4.

The target temperature value calculation apparatus 203 updates the target value of the temperature of the cooling water in the reactor pressure vessel 6 based on the saturation temperature calculated by the saturation temperature calculation apparatus 201 and the subcooling ΔT updated by the subcooling calculation apparatus 202, and control of the additional heating control limit for the heater 16 is performed. Because it is not necessary to increase the subcooling above the subcooling for the value of point T0 prior to heating, heating using the heater 16 is stopped due to the control in this case.

If the output from the proportional-integral calculator 206 is zero or less, the second contact of the switch 208 is controlled so as to be in the OFF state and supply of power source voltage from the heater power source 35 to the heater 16 is stopped. As a result, the heating of the cooling water purified by the CUW apparatus 15 is stopped. When the pressure in the reactor pressure vessel 6 reaches the pre-set high rated pressure, or in other words, the preset target pressure 36, the first contact of the switch 207 is controlled so as to be in the OFF state by the pressure determining device 209, and the calculated value is not output from the proportional-integral calculator 206. The second contact of the switch 208 is controlled to be in the OFF state by the OFF output from the switch 207, and supply of power source voltage from the heater power source 35 to the heater 16 is stopped.

According to the control method of the present embodiment, the subcooling is controlled by controlling the temperature of the cooling water due to heating processing at the time of start-up of the nuclear reactor system.

For this reason, the reactor can be stably controlled without entering the unstable region, which is determined by the relationship between the reactor pressure, the reactor power and the subcooling of the core inlet coolant at start-up time. Furthermore, by using the CUW apparatus 15 at start-up time, the circulation efficiency of the natural circulation system can be increased.

When the control of the present embodiment is not carried out, if the control rod 3 is withdrawn at the maximum temperature increase rate and the reactor water temperature and the reactor pressure are increased, the reactor may operate at point T6 in FIG. 12, or in other words, in the unstable region, and reactor stability becomes problematic.

If the control rod 3 is withdrawn from the core 4 at the temperature increase rate at point T5 in FIG. 12 and the reactor water temperature is increased in order to avoid the unstable region, it takes a long time to reach the rated reactor pressure, and as a result, a problem arises in that the plant start-up time becomes longer.

In other words, the present embodiment is shortened the plant start-up time, because the subcooling is controlled and operation of the reactor can be done outside the unstable region, and the temperature increase range for the reactor per unit of time, can be controlled to be a suitably selected value that is up to the maximum value.

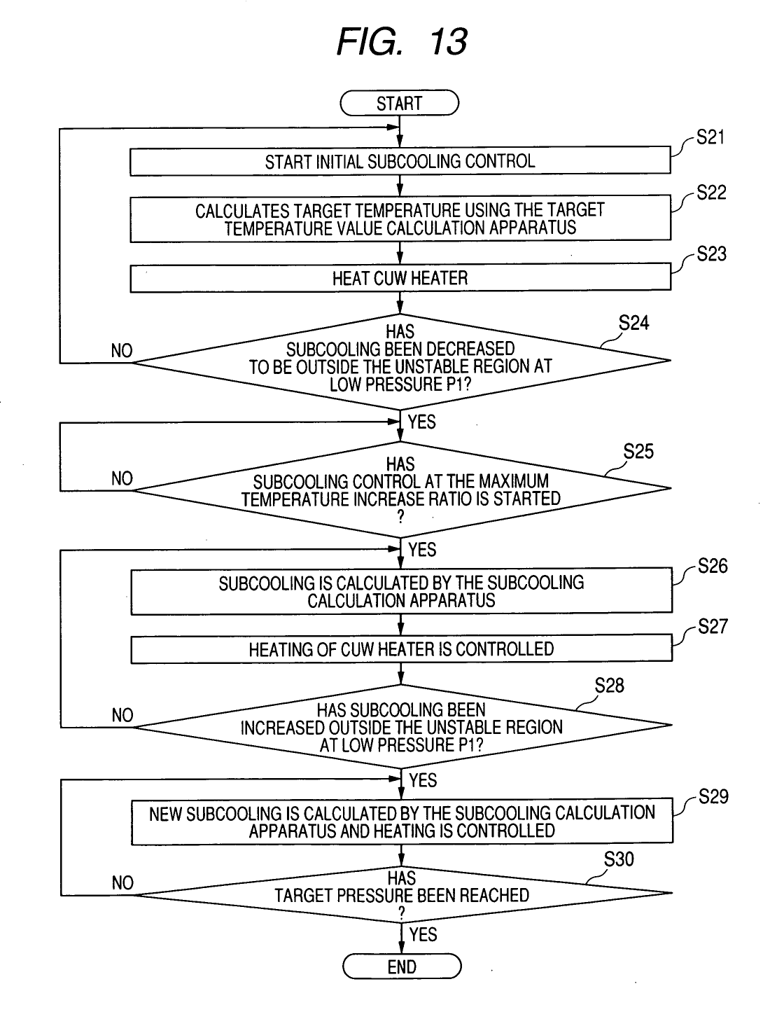

Next, a specific example of the operation for controlling the subcooling will be described with reference to FIG. 13 which is a flowchart showing the operation for controlling the subcooling. The description here will be done on the basis that cleaning of the reactor water using the CUW apparatus 15 has already been described. It is to be noted that the subject of the operations of the flowchart in FIG. 13 is always the control apparatus 20.

First, the control apparatus 20 inputs the external command “initial subcooling control” and initial subcooling control begins (Step S21).

The control apparatus 20 calculates the target temperature using the target temperature value calculation apparatus 203 (Step S22).

The control apparatus 20 controls the heater 16 provided in the CUW apparatus 15 such that the second contact of the switch 208 is in the ON state using the output from the switch 207, and the purified cooling water is heated by supplying power voltage from the heater power source 35 to the heater 16 (Step S23).

In Step S24, a determination is made as to whether the subcooling is outside the unstable region formed in accordance with the reactor pressure, the reactor power and the subcooling of the core inlet coolant at the time of start-up of the nuclear reactor system (at low pressure P1) has been reached, in other words if the target temperature of Step S22 has been reached. If the target temperature has been reached the procedure advances to Step S25.

The control apparatus 20 checks if the external command “subcooling control at the maximum temperature increase rate” has been input, and starts the control of the subcooling at the maximum temperature increase rate when it has been input (Step S25).

The subcooling is calculated by the subcooling calculation apparatus 202. (Step S26).

The control apparatus 20 controls the contact of the switch 208 to be in the ON and OFF state using the output from the switch 207, and controls the power voltage supply from the heater power source 35 to the heater 16 provided in the CUW apparatus 15 in order to control the heat intensity of the heater 16 (Step S27).

The control apparatus 20 determines whether the subcooling calculated by the subcooling calculation apparatus 202 has increased to the value of the point T3 value (shown in FIG. 12) until the subcooling is outside the unstable region formed in accordance with the reactor pressure, the reactor power and the subcooling of the core inlet coolant. (Step S28).

In the case where a determination is made as to whether the subcooling has increased to point T3 which is outside the unstable region at low pressure (low pressure P1) in the determination Step S28, and it is determined that the subcooling has been increased to this point, heat control limiting for the heater 16 is performed by updating the subcooling calculated by the subcooling calculation apparatus 202 in accordance with pressure. When the calculated subcooling is higher than the subcooling for the value of the point T0 prior to heating, the heating using the heater 16 is stopped due to this control (Step S29).

The control apparatus 20 determines whether the pressure in the reactor pressure vessel 6 has reached the pre-set target pressure 36 using the pressure determining device 209 (Step S30). When the target pressure 36 is reached, the control process ends.

An embodiment of this invention has been described above, but this invention is not to be limited to the above embodiment. Needless to say, this invention includes various embodiments provided that they do not depart from the general spirit of this invention described in the scope of the claims.

The embodiment has been described in which the heating control of the heater 16 is done by ON and OFF control by the switch 208, but the switch 208 may be replaced by an inverter, and the voltage output and output current of the inverter may be controlled by the output of the switch 207.

What is claimed is:

1. A nuclear reactor system having a coolant ascending path and a coolant descending path formed inside a reactor pressure vessel, and including a natural circulation system circulating the coolant due to the difference in density of reactor water in the coolant ascending path and the reactor water in the coolant descending path, comprising:
a power control section apparatus which receives a reactor water temperature change rate set value and which outputs control rod operation signals, which are generated based upon the inputted reactor water temperature change rate set value, for control of withdrawing of the control rod from a core in the reactor pressure vessel or for control of inserting of the control rod into the core;
a feed water control apparatus which receives a reactor water level signal and which outputs at least one of a feed water flow rate signal for control of supply of feed water into the reactor pressure vessel and a discharge water flow rate signal for control of exhausting of discharge water from the reactor pressure vessel, generated based on the reactor water level signal; and
a process computing section for overall control of the power control apparatus and the feed water control apparatus,
wherein the feed water control apparatus has a temperature change rate setting section which receives a reactor pressure signal and a core inlet temperature signal and which outputs the water temperature change rate set value determined based on a pre-stored function and at least the reactor pressure signal and the core inlet temperature signal.

2. The nuclear reactor system according to claim 1, wherein the feed water control apparatus has an interlock signal generation section which outputs a rod block signal when a variation of the reactor water level signal is greater than a pre-set set value for blocking withdrawal of the control rod from the core.

3. The nuclear reactor system according to claim 1, wherein the feed water control apparatus has an interlock signal generation section which outputs a pre-selected control rod insertion signal when a variation of the reactor water level signal is greater than a set value for controlling insertion of the control rod into the core.

4. The nuclear reactor system according to claim 1, wherein the pre-stored function of the feed water control apparatus is such that:
the reactor water temperature change rate set value is at least a first value to the extent that the reactor pressure based on the reactor pressure signal is at least a second value; and
the reactor water temperature change rate set value is at least the first value to the extent that a core inlet port temperature based on the core inlet temperature signal is not greater than a third value.

5. The nuclear reactor system according to claim 4, wherein the temperature change rate setting section has a storage memory including a saturated water enthalpy table and a compressed water enthalpy table, and a temperature change rate set value calculation section which calculates the water temperature change rate set value based on the pre-stored function, the saturated water enthalpy table, the compressed water enthalpy table and at least the reactor pressure signal and the core inlet temperature signal.
